(19) United States
(12) Patent Application Publication
(10) Pub. No.: US 2024/0333358 A1
(43) Pub. Date: Oct. 3, 2024

(54) PMI FEEDBACK-BASED CALIBRATION IN DISTRIBUTED MIMO

(71) Applicant: Samsung Electronics Co., Ltd., Suwon-si (KR)

(72) Inventors: R A Nadisanka Perera Rupasinghe, Mckinney, TX (US); Yang Li, Plano, TX (US); Thuy Van Nguyen, Dallas, TX (US); Jianzhong Zhang, Dallas, TX (US)

(21) Appl. No.: 18/525,682

(22) Filed: Nov. 30, 2023

Related U.S. Application Data
(60) Provisional application No. 63/455,122, filed on Mar. 28, 2023.

(51) Int. Cl. H04B 7/06; H04L 5/00

(52) U.S. Cl. CPC H04B 7/0639; H04B 7/0626; H04B 7/063; H04L 5/0051

(57) ABSTRACT

A method of operating a network entity includes receiving, from a UE, via a first TRP and a second TRP, a SRS, and estimating a channel based on the received SRS. The method further includes, for N iterations: transmitting, via the first TRP, a CSI-RS with a first polarization; transmitting, via the second TRP, the CSI-RS with a second polarization and a controlled phase offset; receiving, from the user equipment UE, a PMI report associated with the CSI-RS including co-phasing information between the first polarization and the second polarization; and updating the controlled phase offset, based on the co-phasing information. After the N iterations, the method further includes, based on the controlled phase offset and the co-phasing information, determining a phase mis-match for phase calibration between the first TRP and the second TRP.

### CROSS-REFERENCE TO RELATED APPLICATION(S) AND CLAIM OF PRIORITY

This application claims priority under 35 U.S.C. § 119(e) to U.S. Provisional Patent Application No. 63/455,122 filed on Mar. 28, 2023. The above-identified provisional patent application is hereby incorporated by reference in its entirety.

### TECHNICAL FIELD

This disclosure relates generally to wireless networks. More specifically, this disclosure relates to precoding matrix indicator (PMI) feedback-based calibration in distributed multiple-input, multiple-output (MIMO) wireless communication systems.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides methods and apparatuses for PMI feedback-based calibration in distributed MIMO.

In one embodiment, a network entity is provided. The network entity includes a memory and a processor operably couple to the memory. The processor is configured to receive, from a user equipment (UE), via a first transmit-receive point (TRP) and a second TRP, a sounding reference signal (SRS) and estimate a channel based on the received SRS. The processor is further configured to, for N iterations: transmit, via the first TRP, a channel state information reference signal (CSI-RS) with a first polarization; transmit, via the second TRP, the CSI-RS with a second polarization and a controlled phase offset; receive, from the user equipment UE, a PMI report associated with the CSI-RS including co-phasing information between the first polarization and the second polarization; and update the controlled phase offset, based on the co-phasing information. After the N iterations, the processor is further configured to, based on the controlled phase offset and the co-phasing information, determine a phase mis-match for phase calibration between the first TRP and the second TRP.

In another embodiment, a UE is provided. The UE includes a processor configured to generate PMI reports, and a transceiver operably coupled to the processor. The transceiver is configured to transmit a SRS, and for N iterations: receive, via a TRP, a CSI-RS with a first polarization; receive, via a second TRP, the CSI-RS with a second polarization and a controlled phase offset; and transmit a PMI report associated with the CSI-RS, generated by the processor, including co-phasing information between the first polarization and the second polarization.

In yet another embodiment, a method of operating a network entity is provided. The method includes receiving, from a UE, via a first TRP and a second TRP, a SRS, and estimating a channel based on the received SRS. The method further includes, for N iterations: transmitting, via the first TRP, a CSI-RS with a first polarization; transmitting, via the second TRP, the CSI-RS with a second polarization and a controlled phase offset; receiving, from the user equipment UE, a PMI report associated with the CSI-RS including co-phasing information between the first polarization and the second polarization; and updating the controlled phase offset, based on the co-phasing information. After the N iterations, the method further includes, based on the controlled phase offset and the co-phasing information, determining a phase mis-match for phase calibration between the first TRP and the second TRP.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIG. 2 illustrates an example network entity according to embodiments of the present disclosure;

FIG. 3 illustrates an example UE according to embodiments of the present disclosure;

FIG. 4 illustrates an example gNB according to embodiments of the present disclosure;

FIG. 5 illustrates an example of antenna blocks or arrays according to embodiments of the present disclosure;

FIG. 6 illustrates an example of distributed MIMO according to embodiments of the present disclosure;

FIG. 7 illustrates an example of distributed MIMO according to embodiments of the present disclosure;

FIG. 8 illustrates an example of UE-aided calibration based on type-I single panel codebook;

FIG. 9 illustrates an example 32-port CSI-RS resource configuration for phase calibration among two gNBs or TRPs;

FIG. 10 illustrates an example of a Type I single-panel codebook according to embodiments of the present disclosure;

FIG. 11 illustrates an example RRC parameter typeI-SinglePanel-ri-Restriction according to embodiments of the present disclosure;

FIG. 12 illustrates an example of SRS periodicity;

FIG. 13 illustrates an example of SRS periodicity;

FIG. 14 illustrates a method for PMI feedback-based calibration in distributed MIMO performed by a network entity according to embodiments of the present disclosure;

FIG. 15 illustrates a method for PMI feedback-based calibration in distributed MIMO performed by a UE according to embodiments of the present disclosure; and

FIG. 16 illustrates a method for PMI feedback-based calibration in distributed MIMO performed by a network entity according to embodiments of the present disclosure.

### DETAILED DESCRIPTION

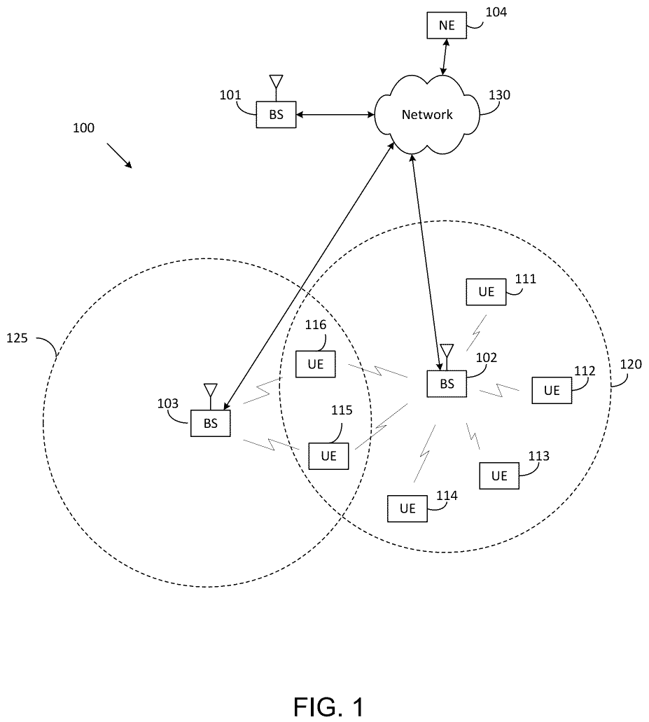

FIGS. 1 through 16, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive MIMO, full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents and standards descriptions are hereby incorporated by reference into the present disclosure as if fully set forth herein:
[1] 3GPP TS 36.211 v16.4.0, “E-UTRA, physical channels and modulation.”
[2] 3GPP TS 36.212 v16.4.0, “E-UTRA, Multiplexing and Channel coding.”
[3] 3GPP TS 36.213 v16.4.0, “E-UTRA, physical Layer Procedures.”
[4] 3GPP TS 36.321 v16.3.0, “E-UTRA, Medium Access Control (MAC) protocol specification.”
[5] 3GPP TS 36.331 v16.3.0, “E-UTRA, Radio Resource Control (RRC) Protocol Specification.”
[6] 3GPP TS 38.211 v16.4.0, “NR, physical channels and modulation.”
[7] 3GPP TS 38.212 v16.4.0, “NR, Multiplexing and Channel coding.”
[8] 3GPP TS 38.213 v16.4.0, “NR, physical Layer Procedures for Control.”
[9] 3GPP TS 38.214 v16.4.0, “NR, physical Layer Procedures for Data.”
[10] 3GPP TS 38.215 v16.4.0, “NR, physical Layer Measurements.”
[11] 3GPP TS 38.321 v16.3.0, “NR, Medium Access Control (MAC) protocol specification.”

[12] 3GPP TS 38.331 v16.3.1, “NR, Radio Resource Control (RRC) Protocol Specification.”

FIGS. 1-4 below describe various embodiments implemented in wireless communications systems and with the use of orthogonal frequency division multiplexing (OFDM) or orthogonal frequency division multiple access (OFDMA) communication techniques. The descriptions of FIGS. 1-4 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the network entity (NE) 104, the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 and NE 104 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for PMI feedback-based calibration in distributed MIMO. In certain embodiments, network entity 104 includes circuitry, programing, or a combination thereof, to support PMI feedback-based calibration in distributed MIMO in a wireless communication system. In certain embodiments, one or more of the gNBs 101-103 includes circuitry, programing, or a combination thereof, to support timing mis-match calibration in distributed MIMO in a wireless communication system.

Although FIG. 1 illustrates one example of a wireless network, various changes may be made to FIG. 1. For example, the wireless network could include any number of gNBs, network entities, and any number of UEs in any suitable arrangement. Also, the gNB 101 could communicate directly with any number of UEs and provide those UEs with wireless broadband access to the network 130. Similarly, each gNB 102-103 could communicate directly with the network 130 and network entity 104 and provide UEs with direct wireless broadband access to the network 130. Further, the gNBs 101, 102, and/or 103 and/or network entity 104 could provide access to other or additional external networks, such as external telephone networks or other types of data networks.

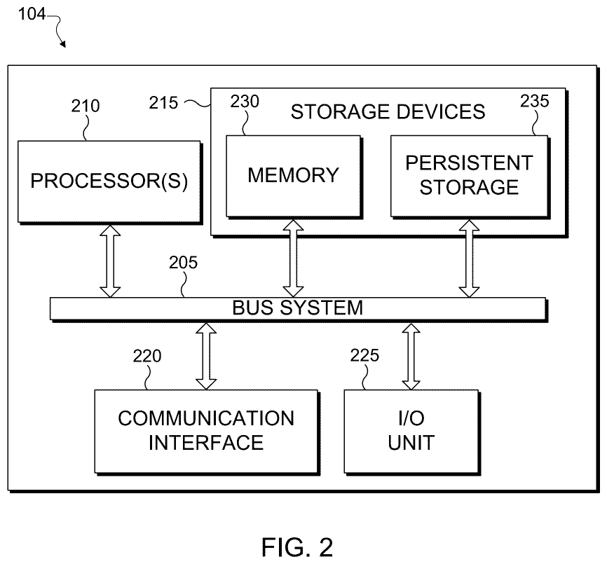

FIG. 2 illustrates an example network entity (NE) 104 according to embodiments of the present disclosure. The embodiment of the NE 104 illustrated in FIG. 2 is for illustration only. However, NEs come in a wide variety of configurations, and FIG. 2 does not limit the scope of this disclosure to any particular implementation of an NE.

The network entity 104 can represent one or more local computing resources, remote computing resources, clustered computing resources, components that act as a single pool of seamless computing resources, a cloud-based computing resource, a virtualized computing resource, and the like. The network entity 104 can be accessed by one or more of the gNBs 101-103 and UEs 111-116 of FIG. 1 or another network entity.

As shown in FIG. 2, the network entity 104 includes a bus system 205 that supports communication between at least one processing device (such as a processor 210), at least one storage device 215, at least one communications interface 220, and at least one input/output (I/O) unit 225.

The processor 210 executes instructions that can be stored in a memory 230. The processor 210 can include any suitable number(s) and type(s) of processors or other devices in any suitable arrangement. Example types of processors 210 include microprocessors, microcontrollers, digital signal processors, field programmable gate arrays, application specific integrated circuits, and discrete circuitry. In certain embodiments, the processor 210 can execute processes to support PMI feedback-based calibration in distributed MIMO.

The memory 230 and a persistent storage 235 are examples of storage devices 215 that represent any structure(s) capable of storing and facilitating retrieval of information (such as data, program code, or other suitable information on a temporary or permanent basis). The memory 230 can represent a random-access memory or any other suitable volatile or non-volatile storage device(s). For example, the instructions stored in the memory 230 can include instructions for supporting timing mis-match calibration in distributed MIMO. The persistent storage 235 can contain one or more components or devices supporting longer-term storage of data, such as a read only memory, hard drive, Flash memory, or optical disc.

The communications interface 220 supports communications with other systems or devices. For example, the communications interface 220 could include a network interface card or a wireless transceiver facilitating communications over the network 102 of FIG. 1. The communications interface 220 can support communications through any suitable physical or wireless communication link(s). For example, the communications interface 220 can transmit operation instructions to another device such as one of gNBs 101, 102, and 103.

The I/O unit 225 allows for input and output of data. For example, the I/O unit 225 can provide a connection for user input through a keyboard, mouse, keypad, touchscreen, or other suitable input device. The I/O unit 225 can also send output to a display, printer, or other suitable output device. Note, however, that the I/O unit 225 can be omitted, such as when I/O interactions with the network entity 104 occur via a network connection.

While the various components of network entity 104 are illustrated as discrete components such as processor 210, memory 230, and communications interface 220, all components or a subset of components of network entity 104 may be implemented as virtual components in a virtual resource, such as a virtual machine, a virtual server, software emulation, hardware emulation, and the like. In some embodiments, network entity 104 may be a virtual resource. In some embodiments, network entity 104 may be implemented entirely as computer program code operating on a separate apparatus.

In some circumstances, network entity 104 may be integrated into another apparatus. For example, network entity 104 may be integrated into gNB 102. For instance, gNB 102 may include hardware that performs the functions of network entity 104, may include virtual resources that perform the functions of network entity 104, may include software that performs the functions of network entity 104, and/or gNB 102 may perform the functions of network entity 104 as an inherent feature of gNB 102.

In some circumstances, a network entity may be implemented across multiple apparatuses. For example, network entity 104 may be implemented across gNB 102 and gNB 103 such that gNB 102 and gNB 103 form a single network entity 104.

Note that while FIG. 2 is described as representing the network entity 104 of FIG. 1, the same or similar structure could be used in one or more of the gNBs 101, 102, and 103.

Although FIG. 2 illustrates an example network entity, various changes can be made to FIG. 2. For example, various components in FIG. 2 could be combined, further subdivided, or omitted and additional components could be added according to particular needs. As a particular example, the processor 210 could be divided into multiple processors, such as one or more central processing units (CPUs).

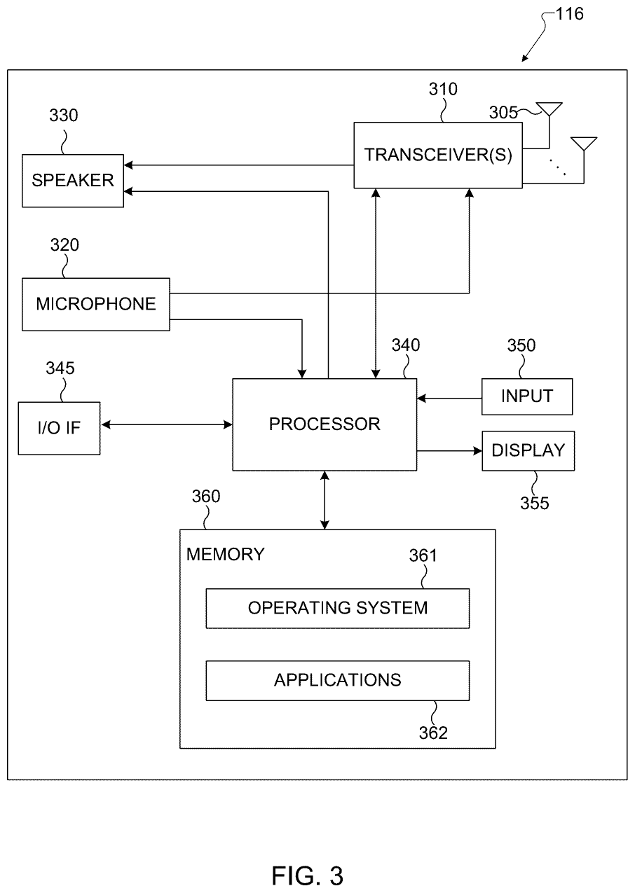

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for PMI feedback-based calibration in distributed MIMO as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

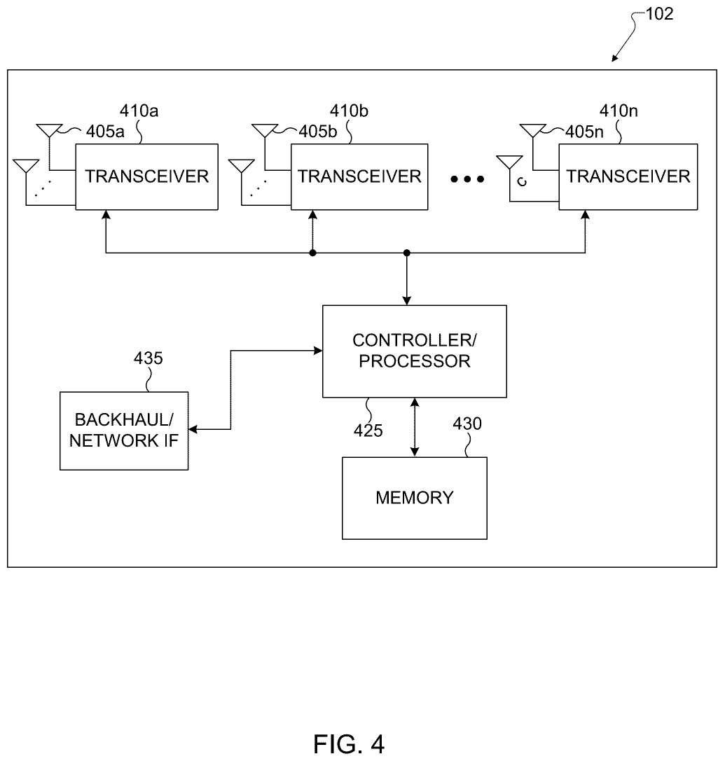

FIG. 4 illustrates an example gNB 102 according to embodiments of the present disclosure. The embodiment of the gNB 102 illustrated in FIG. 4 is for illustration only, and the gNBs 101 and 103 of FIG. 1 could have the same or similar configuration. However, gNBs come in a wide variety of configurations, and FIG. 4 does not limit the scope of this disclosure to any particular implementation of a gNB.

As shown in FIG. 4, the gNB 102 includes multiple antennas 405a-405n, multiple transceivers 410a-410n, a controller/processor 425, a memory 430, and a backhaul or network interface 435.

The transceivers 410a-410n receive, from the antennas 405a-405n, incoming RF signals, such as signals transmitted by UEs in the network 100. The transceivers 410a-410n down-convert the incoming RF signals to generate IF or baseband signals. The IF or baseband signals are processed by receive (RX) processing circuitry in the transceivers 410a-410n and/or controller/processor 425, which generates processed baseband signals by filtering, decoding, and/or digitizing the baseband or IF signals. The controller/processor 425 may further process the baseband signals.

Transmit (TX) processing circuitry in the transceivers 410a-410n and/or controller/processor 425 receives analog or digital data (such as voice data, web data, e-mail, or interactive video game data) from the controller/processor 425. The TX processing circuitry encodes, multiplexes, and/or digitizes the outgoing baseband data to generate processed baseband or IF signals. The transceivers 410a-410n up-converts the baseband or IF signals to RF signals that are transmitted via the antennas 405a-405n.

The controller/processor 425 can include one or more processors or other processing devices that control the overall operation of the gNB 102. For example, the controller/processor 425 could control the reception of UL channel signals and the transmission of DL channel signals by the transceivers 410a-410n in accordance with well-known principles. The controller/processor 425 could support additional functions as well, such as more advanced wireless communication functions. For instance, the controller/processor 425 could support beam forming or directional routing operations in which outgoing/incoming signals from/to multiple antennas 405a-405n are weighted differently to effectively steer the outgoing signals in a desired direction. Any of a wide variety of other functions could be supported in the gNB 102 by the controller/processor 425.

The controller/processor 425 is also capable of executing programs and other processes resident in the memory 430, such as an OS and, for example, processes to support PMI feedback-based calibration in distributed MIMO as discussed in greater detail below. The controller/processor 425 can move data into or out of the memory 430 as required by an executing process.

The controller/processor 425 is also coupled to the backhaul or network interface 435. The backhaul or network interface 435 allows the gNB 102 to communicate with other devices or systems over a backhaul connection or over a network. The interface 435 could support communications over any suitable wired or wireless connection(s). For example, when the gNB 102 is implemented as part of a cellular communication system (such as one supporting 5G/NR, LTE, or LTE-A), the interface 435 could allow the gNB 102 to communicate with other gNBs over a wired or wireless backhaul connection. When the gNB 102 is implemented as an access point, the interface 435 could allow the gNB 102 to communicate over a wired or wireless local area network or over a wired or wireless connection to a larger network (such as the Internet). The interface 435 includes any suitable structure supporting communications over a wired or wireless connection, such as an Ethernet or transceiver.

The memory 430 is coupled to the controller/processor 425. Part of the memory 430 could include a RAM, and another part of the memory 430 could include a Flash memory or other ROM.

Although FIG. 4 illustrates one example of gNB 102, various changes may be made to FIG. 4. For example, the gNB 102 could include any number of each component shown in FIG. 4. Also, various components in FIG. 4 could be combined, further subdivided, or omitted and additional components could be added according to particular needs.

For a cellular system operating in low carrier frequency in general, a sub-1 GHz frequency range (e.g., less than 1 GHz) as an example, supporting large number of CSI-RS antenna ports (e.g., 32) or many antenna elements at a single location or remote radio head (RRH) is challenging due to a larger antenna form factor size needed considering carrier frequency wavelength than a system operating at a higher frequency such as 2 GHz or 4 GHz. At such low frequencies, the maximum number of CSI-RS antenna ports that can be co-located at a site (or RRH) can be limited, for example to 8. This limits the spectral efficiency of such systems. In particular, the MU-MIMO spatial multiplexing gains offered due to large number of CSI-RS antenna ports (such as 32) can't be achieved due to the antenna form factor limitation. One way to operate a system with large number of CSI-RS antenna ports at low carrier frequency is to distribute the physical antenna ports to different panels/RRHs, which can be possibly non-collocated. The multiple sites or panels/RRHs can still be connected to a single (common) base unit forming a single antenna system, hence the signal transmitted/received via multiple distributed RRHs can still be processed at a centralized location. For example, the multiple distributed RRHs could be processed by a network entity, such as network entity 104 FIG. 1.

The present disclosure considers such a system (called distributed MIMO or multi-transmission-reception point (mTRP) or coherent joint transmission (CJT)) and proposes methods to perform calibration for the RF receive/transmit antenna network of multiple RRHs/panels in the system to utilize DL/UL channel reciprocity, where the proposed methods can be realized based on Type I single panel codebook and feedback design.

Calibration is an important issue for distributed MIMO in general. Massive MIMO base stations use an on-board coupling network and calibration circuits, which are referred to herein as the on-board calibration for brevity, to measure the gain and phase differences among transceivers in the same radio frequency (RF) unit in order to maintain the reciprocity between DL and UL channels in the TDD system. For the on-board calibration, one RF chain corresponding to one antenna port serves as a reference to other RF chains for other antenna ports. In the case of the distributed MIMO, such reference transceiver's signal needs to be shared between distributed RRHs/panels/modules, which are physically far apart. Using RF cables to distribute the reference is not preferable as it limits the deployment scenarios. In the distributed MIMO, the use of different local oscillators (Los) between distributed antenna modules imposes even more challenges in achieving calibration as the phase of Los could drift. Periodic calibration is needed to compensate for the phase drift as well.

The present disclosure describes over-the-air (OTA) signaling mechanisms and calculation algorithms for calibration among the RRHs/panels of distributed MIMO networks. One of the described mechanisms comprises UL RS transmission and UL channel estimation, (beamformed) DL RS transmission/reception based on UL channel estimation and calibration coefficient estimation, multiple CSI (RI/PMI/CQI) reporting, and gNB calculation based on reported CSI.

Although the present disclosure is described based on 3GPP 5G NR communication systems, various embodiments may apply in general to UEs operating with other RATs and/or standards, such as different releases/generations of 3GPP standards (including beyond 5G, 6G, and so on), IEEE standards (such as 802.16 WiMAX and 802.11 Wi-Fi), and so on.

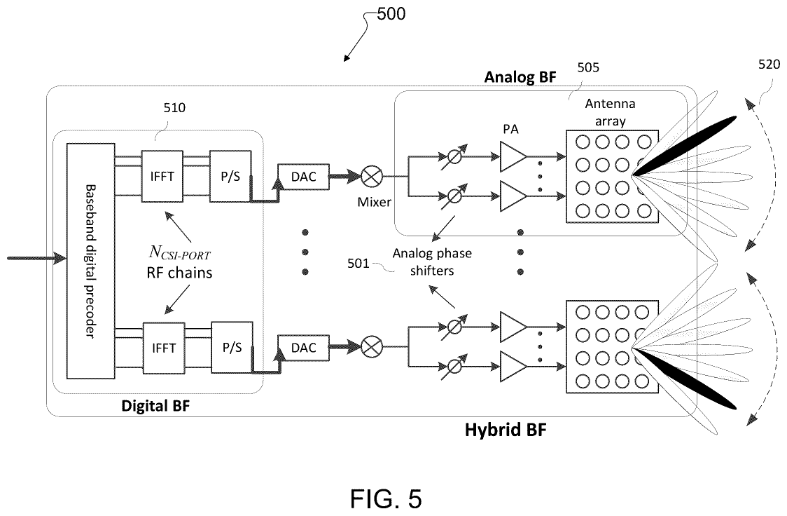

FIG. 5 illustrates an example of antenna blocks or arrays 500 according to embodiments of the present disclosure. The embodiment of the antenna blocks or arrays 500 illustrated in FIG. 5 is for illustration only. Different embodiments of antenna blocks or arrays 500 could be used without departing from the scope of this disclosure.

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports —which can correspond to the number of digitally precoded ports-tends to be limited due to hardware constraints (such as the feasibility to install a large number of ADCs/DACs at mmWave frequencies) as illustrated in FIG. 5. In this case, one CSI-RS port is mapped onto a large number of antenna elements which can be controlled by a bank of analog phase shifters 501. One CSI-RS port can then correspond to one sub-array which produces a narrow analog beam through analog beamforming 505. This analog beam can be configured to sweep across a wider range of angles (520) by varying the phase shifter bank across symbols or subframes. The number of sub-arrays (equal to the number of RF chains) is the same as the number of CSI-RS ports NCSI-PORT. A digital beamforming unit 510 performs a linear combination across NCSI-PORT analog beams to further increase precoding gain. While analog beams are wideband (hence not frequency-selective), digital precoding can be varied across frequency sub-bands or resource blocks. Receiver operation can be conceived analogously.

Although FIG. 5 illustrates one example of example antenna blocks or arrays 400, various changes may be made to FIG. 5. For example, the example antenna blocks or arrays 500 could include any number of each component shown in FIG. 5. Also, various components in FIG. 5 could be combined, further subdivided, or omitted and additional components could be added according to particular needs.

Since the above system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL transmit (TX) beam (also termed “beam indication”), measuring at least one reference signal for calculating and performing beam reporting (also termed “beam measurement” and “beam reporting”, respectively), and receiving a DL or UL transmission via a selection of a corresponding receive (RX) beam.

The above system is also applicable to higher frequency bands such as >52.6 GHz (also termed the FR4). In this case, the system can employ only analog beams. Due to the O2 absorption loss around 60 GHz frequency (˜10 dB additional loss @100 m distance), larger number of and sharper analog beams (hence larger number of radiators in the array) will be needed to compensate for the additional path loss.

At lower frequency bands such as FRI or particularly sub-1 GHz band, on the other hand, the number of antenna elements cannot be increased in a given form factor due to large wavelength if a critical distance (≥2/2) between two adjacent antenna elements is maintained in deployment scenarios. As an example, for the case of the wavelength size (A) of the center frequency 600 MHz (which is 50 cm), it requires 4 m for uniform-linear-array (ULA) antenna panel of 16 antenna elements with the half-wavelength distance between two adjacent antenna elements. Considering a plurality of antenna elements is mapped to one digital port in practical cases, the required size for antenna panels at gNB to support a large number of antenna ports, e.g., 32 CSI-RS ports, becomes very large in such low frequency bands, and it leads to the difficulty of deploying 2-D antenna arrays within the size of a conventional form factor. This can result in a limited number of physical antenna elements and, subsequently CSI-RS ports, that can be supported at a single site and limit the spectral efficiency of such systems.

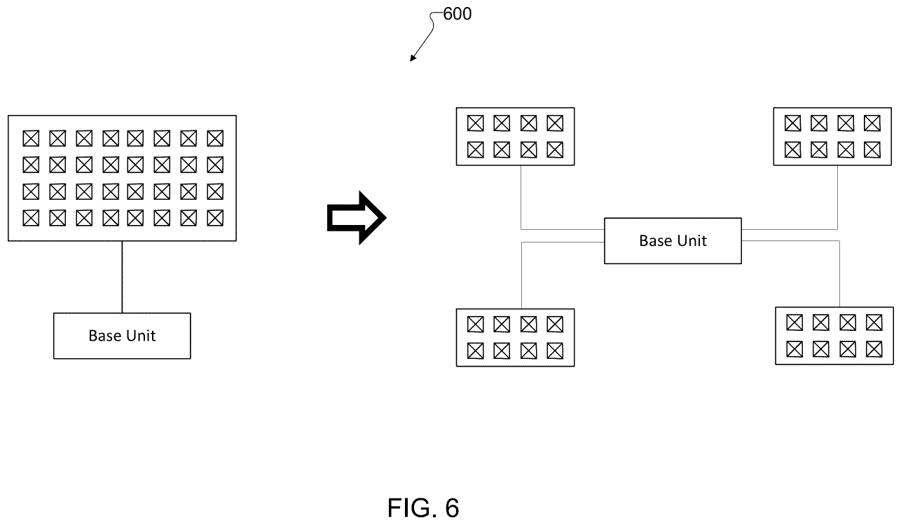

One possible approach to resolve the issue is to form multiple antenna panels (e.g., antenna modules, RRHs) with a small number of antenna ports instead of integrating all of the antenna ports in a single panel (or at a single site) and to distribute the multiple panels in multiple locations/sites (or RRHs), as illustrated in FIG. 6.

FIG. 6 illustrates an example of distributed MIMO 600 according to embodiments of the present disclosure. In the example of FIG. 6, distributed MIMO 600 is formed from multiple antenna panels, such as antenna modules or RRHs, with a small number of antenna ports instead of integrating all the antenna ports in a single panel or at a single site and distributing the multiple panels in multiple locations/sites or RRHs. The example of FIG. 6 may be implemented by a BS. For example, the example of distributed MIMO 600 may be implemented by one or more BSs such as BS 102. The MIMO 600 is for illustration only and other embodiments can be used without departing from the scope of the present disclosure.

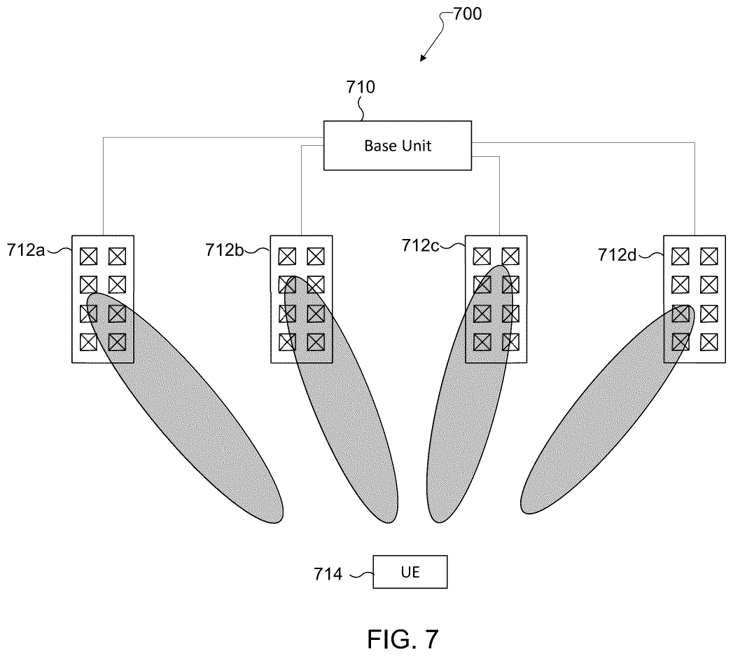

The multiple antenna panels at multiple locations can still be connected to a single base unit, and thus the signal transmitted/received via multiple distributed panels can be processed in a centralized manner through the single base unit, as illustrated in FIG. 7. In another embodiment, it is possible that multiple distributed antenna panels are connected to more than one base units, which communicates with each other and jointly supporting single antenna system.

FIG. 7 illustrates another example of distributed MIMO 700 according to embodiments of the present disclosure. In the example of FIG. 7, multiple antenna locations 712-712d are connected to a single base unit 710. The base unit 710 may process signals transmitted and received via antenna locations 712a-712d in a centralized manner. For example, base unit 710 may process signals transmitted and received to UE 714. The example of FIG. 7 may be implemented by a BS. For example, the distributed MIMO 700 may be implemented by one or more BSs such as BS 102. The example of distributed MIMO 700 is for illustration only and other embodiments can be used without departing from the scope of the present disclosure.

In TDD, a common approach to acquire DL channel state information is to exploit UL channel estimation through receiving UL RSs (e.g., SRS) sent from UE. By using the channel reciprocity in TDD systems, the UL channel estimation itself can be used to infer DL channels. This favorable feature enables NW to reduce the training overhead significantly. However, due to the RF impairment at transmitter and receiver, directly using the UL channels for DL channels is not accurate and it requires a calibration process (periodically) among receive and transmit antenna ports of the RF network at NW. In general, NW has an on-board calibration mechanism in its own RF network to calibrate its antenna panels having a plurality of receiver/transmitter antenna ports, to enable DL/UL channel reciprocity in channel acquisition. The on-board calibration mechanism can be performed via small-power RS transmission and reception from/to the RF antenna network of NW and thus it can be done by NW's implementation in a confined manner (i.e., that does not interfere with other entities). However, it becomes difficult to perform the on-board calibration in distributed MIMO systems due to the distribution of the panels/RRHs over a wide region, and thus it will require over-the-air (OTA) signaling mechanisms to calibrate receive/transmit antenna ports among multiple RRHs/panels far away in distributed MIMO.

The present disclosure proposes UE-assisted calibration mechanisms for distributed MIMO systems. A high-level description of multiple CSI reporting was briefly introduced in U.S. patent application Ser. No. 17/673,641, which is incorporated by reference in its entirety.

Although low-band TDD systems are exemplified for motivation purposes, the present disclosure can be applied to any frequency band in FRI and/or FDD systems.

A UE received signal model for f-th sub-carrier with the joint transmission (JT) can be given as:

$$y ( f ) = ( {h}_{1}^{H} ( f ) {p}_{1} + {e}^{- j {θ}_{TRP}} {h}_{2}^{H} ( f ) {p}_{2} ) x ( f ) + n ,$$

where θ_{TRP}: Common phase mis-match between TRPs
pᵢ, i∈{1,2}: Precoder of i-th TRP

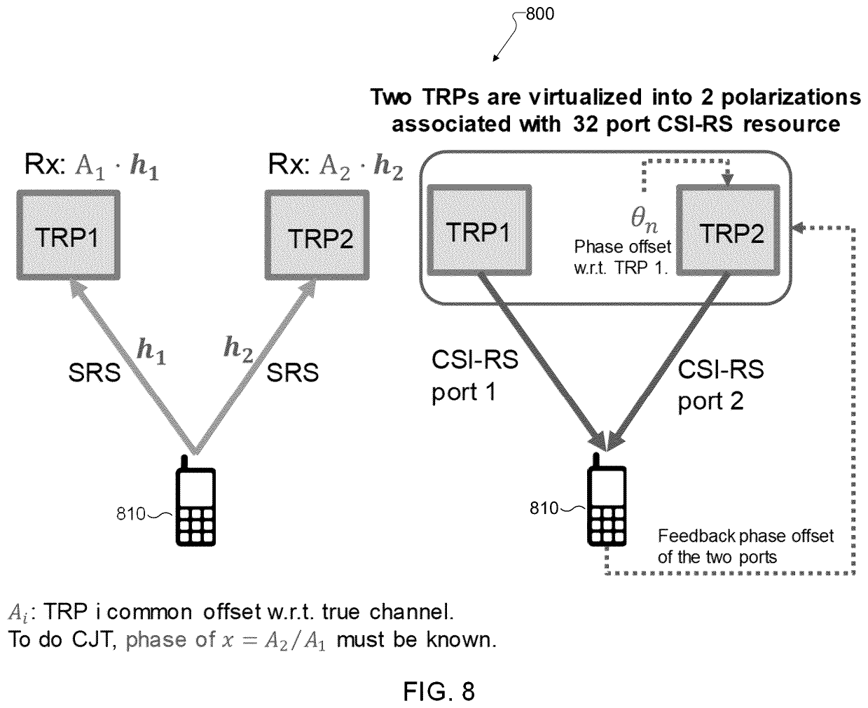

To achieve coherent JT gains, θ_{TRP} needs to be sufficiently calibrated prior to actual data transmission. To aid calibration a UE may be utilized to measure a phase mismatch between two TRPs, and the reported phase mismatch may be used to perform calibration. An example of such a procedure is illustrated in FIG. 8.

FIG. 8 illustrates an example 800 of UE-aided calibration based on type-I single panel codebook. The embodiment of a UE-aided calibration of FIG. 8 is for illustration only. Different embodiments of a UE-aided calibration could be used without departing from the scope of this disclosure.

In the example of FIG. 8, a UE 810 transmits an SRS which is received by TRP 1 and TRP 2. The SRS is received with at each TRP with an offset Aᵢ which is a TRP i common offset with respect to the true channel. To perform coherent joint transmission (CJT), a phase of x=A₂/A₁ must be known. To obtain the phase of A₂/A₁, the two TRPs are virtualized into two polarizations associated with a 32 port CSI-RS resource. Then, for a number of iterations N (e.g., N=3), TRP 1 and TRP 2 transmit a CSR-RS based on the two polarizations, and receive a co-phasing report from UE 810 in the form of a PMI report. At an iteration n, where the number of ports per polarization is N₁N₂:

m-th port of polarization 1: p_{1,m}ⁿ=A₁^{H}h_{1,m}/|h_{1,m}|²,

m-th port of polarization 2: p_{2,m}ⁿ=e^{jθ}^{ₙ}A₂^{H}h_{2,m}/h_{2,m}|², and
the received signal at UE 810 for m-th port:

polarization 1:y₁=A₁^{H}h₁^{H}·p_{l,m}ⁿ+n₁=A₁^{H}++n₁

polarization 2:y₂=A₂^{H}e^{jθ}^{ₙ}+n₂.

32 Tx Type-I PMI quantizes
(A₁^{H}1, A₂^{H} e^{jθ}^{ᵢ}1)˜(1, x^{H}e^{jθn}1).

By combining PMI reports including co-phasing information of N such measurements, one may estimate the phase of x accurately.

Although FIG. 8 illustrates an example 800 of UE-aided calibration based on type-I single panel codebook, various changes may be made to FIG. 8. For example, various changes to the number of CSI-RS ports, the number of TRPs, etc. could be made according to particular needs.

An embodiment of how a 32-port CSI-RS resource can be configured among two gNBs or TRPs for phase calibration purposes is illustrated in FIG. 8.

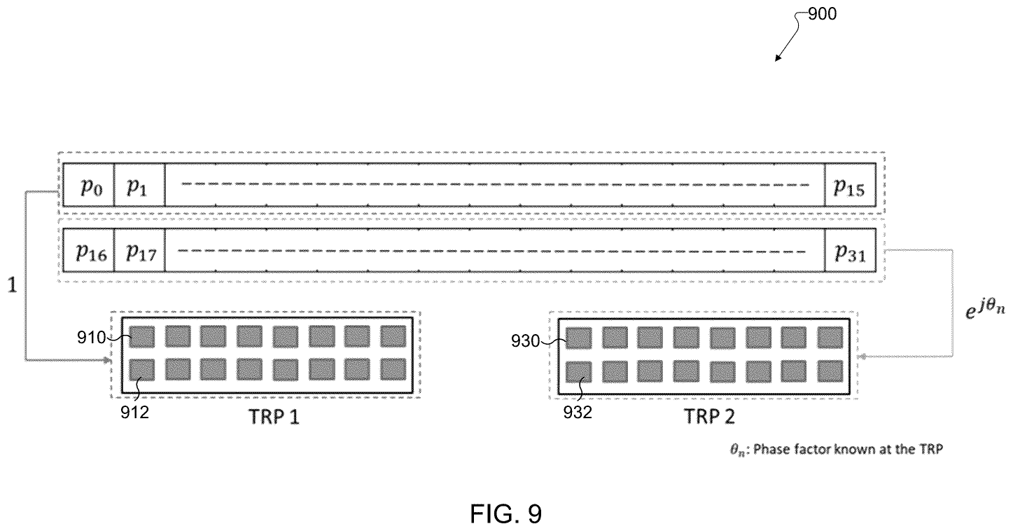

FIG. 9 illustrates an example 32-port CSI-RS resource configuration 900 for phase calibration among two gNBs or TRPs. The embodiment of a 32-port CSI-RS resource configuration of FIG. 9 is for illustration only. Different embodiments of a CSI-RS resource configuration could be used without departing from the scope of this disclosure.

In the example of FIG. 9, the terms gNB and TRP are used interchangeably. Without loss of generality, FIG. 9 illustrates a two TRP case, yet the method described herein can be generalized to more than two TRPs with appropriate SRS and CSI-RS resource configurations.

In the example of FIG. 9 two TRPs, TRP 1 and TRP 2 each comprise sixteen TXRUs. For instance, TRP 1 comprises TXRUs 910 and 912, as well as fourteen additional TXRUs, while TRP 2 comprises TXRUs 930 and 932, as well as fourteen additional TXRUs. TRP 1 and TRP 2 are assigned with 16 CSI-RS ports each from a 32-port CSI-RS resource. For example, it can be seen in FIG. 9 that TRP 1 is assigned ports {p₀, p₁ . . . , p₁₅}, and TRP 2 is assigned ports {p₁₆, p₁₇ . . . , p₃₁}. In this example, Each TXRU of TRP 1 and TRP 2 are assigned with a single CSI-RS port. For example, CSI-RS ports p₁₆ and p₁₇ may be assigned to TXRUs 910 and 912 of TRP 1 respectively, while CSI-RS ports p₁₆ and p₁₇ may be assigned to TXRUs 930 and 932 of TRP 2 respectively. However, it should be understood that a TRP may comprise more than sixteen TXRUs. In one embodiment, if there are 32 or more TXRUs per TRP, then 2 or more TXRUs can be virtualized to a single CSI-RS port. In another embodiment, if the assigned CSI-RS ports for a TRP are less than the available TXRUs for that TRP, only a number of TXRUs equivalent to the available CSI-RS ports is considered.

For the CSI-RS ports {p₀, p₁ . . . p₁₅} assigned to TRP 1, virtualization weights, [1, 1, . . . , 19 ] are applied while for CSI-RS ports {p₁₆, p₁₇ . . . , p₃₁} assigned to TRP 2, virtualization weights [e^{jθ}^{ₙ}, e^{jθ}^{ₙ}, . . . , e^{jθ}^{ₙ}] are applied, as illustrated in FIG. 9.

Although FIG. 9 illustrates an example 32-port CSI-RS resource configuration 900 for phase calibration among two gNBs or TRPs, various changes may be made to FIG. 8. For example, various changes to the number of CSI-RS ports, the number of TXRUs, etc. could be made according to particular needs.

The phase factor On at the n-th iteration is identified in a controlled manner based on the reported PMI, i.e., co-phasing factor, from a single-layer 32-Tx codebook so as to minimize the estimation error. Phase factor On may also be referred to as a controlled phase offset.

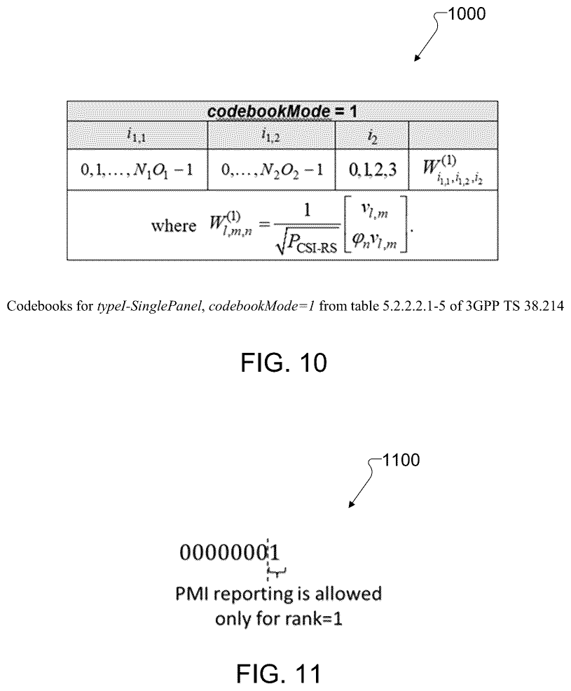

Given the aforementioned 32-port CSI-RS transmission from two TRPs, it is worth reviewing the radio resource control (RRC) configurations associated with PMI reporting. For instance, in the example of FIG. 8, UE 810 should be configured to report PMI from Type I single-panel codebook with RRC signaling, codebookType set to ‘typeI-SinglePanel’ and codebookMode set to 1. The relevant codebook is shown in FIG. 10.

FIG. 10 illustrates an example 1000 of a Type I single-panel codebook according to embodiments of the present disclosure. The embodiment of a Type I single-panel codebook of FIG. 10 is for illustration only. Different embodiments of a Type I single-panel codebook could be used without departing from the scope of this disclosure.

In the example of FIG. 10, codebooks for typeI-SinglePanel, codebookMode=1 from table 5.2.2.2.1-5 of 3GPP TS 38.214 are illustrated.

Although FIG. 10 illustrates an example 1000 of a Type I single-panel codebook, various changes may be made to FIG. 10. For example, various changes to the codebook, the codebook mode, etc. could be made according to particular needs.

Note that, the reported co-phasing factor as part of the PMI should capture relative phase difference between two TRPs. To support that, PMI needs to be from the 1-layer codebook. To restrict the UE to report only rank=1, in one embodiment, RRC parameter typeI-SinglePanel-ri-Restriction can be used. In particular, by setting only the least significant bit (LSB) of an 8-bit sequence to 1 as illustrated in FIG. 11, the UE can be configured to report only rank=1 PMI.

FIG. 11 illustrates an example RRC parameter typeI-SinglePanel-ri-Restriction 1100 according to embodiments of the present disclosure. The embodiment of a RRC parameter FIG. 11 is for illustration only. Different embodiments of a radar-based gesture recognition solution could be used without departing from the scope of this disclosure.

Although FIG. 11 illustrates an example RRC parameter typeI-SinglePanel-ri-Restriction 1000, various changes may be made to FIG. 11 could be made according to particular needs.

In another embodiment, it is possible to configure UE with 2N₁N₂ number of CSI-RS ports. The values of N₁ and N₂ are configured with the RRC parameter n1-n2. Each TRP is assigned with N₁N₂ CSI-RS ports. The remaining procedures discussed subsequently for a 32-port CSI-RS resource regarding phase calibration can be equivalently applied for the 2N₁N₂ CSI-RS ports case well.

Given the aforementioned TXRU virtualization and CSI-RS configurations, the following describes how 32 CSI-RS ports are applied with different precoding, virtualization weights and UE processing of a received beamformed CSI-RS to identify PMI.

For example, let the channel between a UE and a k-th TXRU of a TRP i be, h_{i,k} where i∈{1, 2}, k∈{0, . . . , 15} estimated from an SRS transmission. For this example, single antenna port UE utilized, though the example can be easily extended for multi antenna port UEs as well.

Considering the above example, in one embodiment, each CSI-RS port is applied with the p_{i,k}ⁿ precoding at the n-th iteration as:

$${p}_{1 , k}^{n} = \frac{{h}_{1 , k}}{{\vert {h}_{1 , k} \vert}^{2}} {e}^{- j ( {β}^{tx} + {α}_{1}^{rx} )} \qquad Equation ( 1 )$$

$${p}_{2 , k}^{n} = \frac{{h}_{2 , k}}{{\vert {h}_{2 , k} \vert}^{2}} {e}^{- j ( {β}^{tx} + {α}_{2}^{rx} )} {e}^{j {θ}_{n}} . \qquad Equation ( 2 )$$

Here, e^{jβ}^{^{tx}} is due to the RF impairment of the Tx antenna port of the UE while e^{jα}^{ᵢ}^{^{rx}} is due to the RF impairment of the Rx antenna port of TRP i.

Note that, all CSI-RS ports configured to TRP 2 are applied with virtualization weight, e^{jθ}^{ₙ} at n-th iteration for calibration purposes. Note also that, CSI-RS ports assigned to two TRPs are from different polarizations as per the UE's perspective.

Then, the 16-port channel observed at the UE for m-th polarization h_{Rx}^{m,n}, m∈{1, 2} may be defined as:

$${h}_{Rx}^{1 , n} = {[ \begin{matrix}1 & 1 & … & 1\end{matrix} ]}^{T} \times {e}^{j ( {β}^{Rx} + {α}_{1}^{tx} - {β}^{Tx} - {α}_{1}^{Rx} )} \qquad Equation ( 3 )$$

$${h}_{Rx}^{2 , n} = {[ \begin{matrix}1 & 1 & … & 1\end{matrix} ]}^{T} \times {e}^{j {θ}_{n}} \times {e}^{j ( {β}^{Rx} + {α}_{2}^{tx} - {β}^{Tx} - {α}_{2}^{Rx} )} \qquad Equation ( 4 )$$

Here, e^{jβ}^{^{rx}} is due to the RF impairment of Rx antenna port of UE while e^{jα}^{ᵢ}^{^{tx}} is due to the RF impairment of Tx antenna port of TRP i.

Subsequently, the normalized wideband (WB) channel across two polarizations considering equation (3) and (4) can be given as,

$${h}_{Rx}^{n} = [ \begin{matrix}[ \begin{matrix}1 \\ ⋮ \\ 1\end{matrix} ] \\ [ \begin{matrix}{e}^{j ( {θ}_{n} + {θ}_{TRP} )} \\ ⋮ \\ {e}^{j ( {θ}_{n} + {θ}_{TRP} )}\end{matrix} ]\end{matrix} ] \qquad Equation ( 5 )$$

Here, θ_{TRP}=(α₂^{tx}-α₁^{Rx})−(α₁^{tx}-α₁^{Rx}) is the phase calibration factor to be estimated. Note that, the co-phasing factor reported as part of the PMI captures e^{j(θ}^{ₙ}^{+θ}^{_{TRP}}⁾ which can effectively be utilized for estimating the phase calibration factor.

Given h_{Rx}ⁿ in (5), appropriate co-phasing factor θₗ_{ₛₑₗ}ⁿ at the n-th iteration can be identified using the available co-phasing factors, θₗ∈{0, π/2, π, 3π/2} for Type I single-panel codebookMode=1 codebook. In particular, assuming N₂=1, let Pₗ be the PMI associated with the co-phasing θₗ,

$${P}_{l} = [ \begin{matrix}[ \begin{matrix}1 \\ ⋮ \\ 1\end{matrix} ] \\ {e}^{j {θ}_{l}} [ \begin{matrix}1 \\ ⋮ \\ 1\end{matrix} ]\end{matrix} ] \qquad Equation ( 6 )$$

Then, the θₗ_{ₛₑₗ}ⁿ at the n-th iteration can be identified as,

$${θ}_{{l}_{sel}}^{n} = {arg max}_{{θ}_{l}} {\vert {( {h}_{RX}^{n} )}^{H} {P}_{l} \vert}^{2} \qquad Equation ( 7 )$$

Using θₗ_{ₛₑₗ}ⁿ co-phasing factor, the phase calibration factor θ_{TRP} at the n-th iteration can be given as,

$${θ}_{{l}_{sel}}^{n} + {Δθ}_{n} = {θ}_{n} + {θ}_{TRP} \qquad Equation ( 8 )$$

where, Δθₙ is the estimation error.

Subsequently, assuming Δθₙ is independent and identically distributed with zero mean, using equation (8), θ_{TRP} after a sufficiently large number of iterations can be estimated as,

$$\frac{1}{N} {\sum }_{n = 0}^{N - 1} ( {θ}_{{l}_{sel}}^{n} - {θ}_{n} ) = {θ}_{TRP} -$$

where, N is the number of iterations.

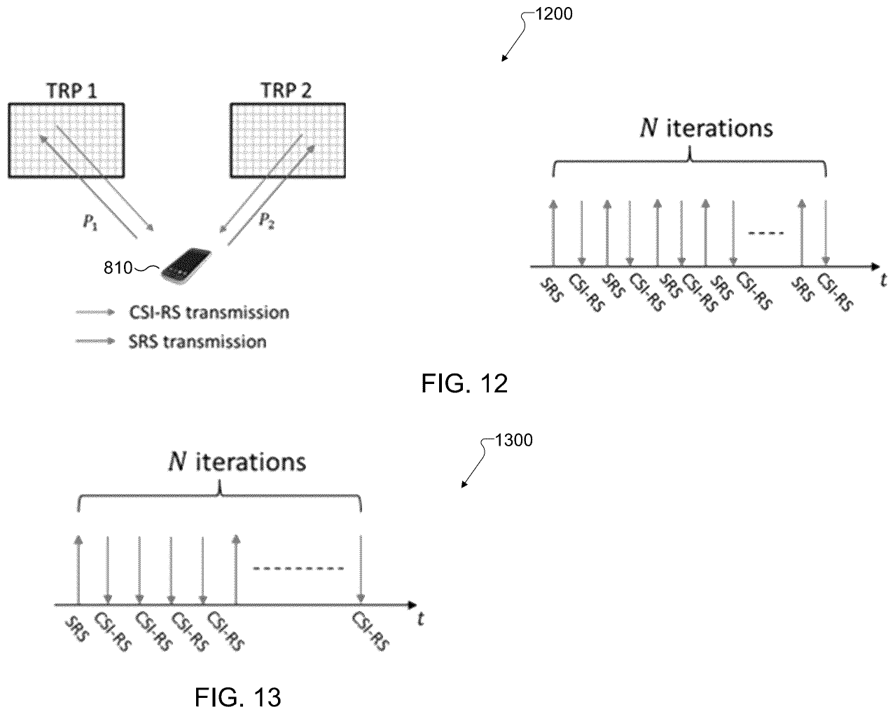

As previously described herein, the phase calibration factor may be estimated after a sufficiently large number of iterations of CSI-RS transmission followed by corresponding PMI reports that include co-phasing reports. However, depending on the rate variation in the channel, the UE may be scheduled to transmit SRS more frequently. The frequency of SRS transmission may be referred to as an SRS periodicity. Depending on the SRS periodicity, it may not be possible for the UE and the TRPs to perform multiple iterations of CSI-RS and PMI reporting between SRS transmission. In some circumstances, an SRS may be transmitted between each CSI-RS and PMI reporting iteration. An example is illustrated in FIG. 12.

FIG. 12 illustrates an example 1200 of SRS periodicity. The example SRS periodicity of FIG. 12 is for illustration only. Different embodiments of SRS periodicity could be used without departing from the scope of this disclosure.

In the example of FIG. 12, UE 810, TRP 1, and TRP 2 are configured such that each SRS transmission from UE 810 is followed by a beamformed CSI-RS transmission from TRP 1 and TRP 2. In the example of FIG. 12, there will be N number of such SRS and beamformed CSI-RS pairs to cover N iterations (corresponding to N PMI reports).

Although FIG. 12 illustrates an example 1200 of SRS periodicity, various changes may be made to FIG. 12. For example, various changes to the number of iterations, the number of TRPs, etc. could be made according to particular needs.

In circumstances where the channel should not vary much between SRS transmissions, the SRS periodicity may be less frequent than depicted in FIG. 12, allowing the UE and the TRPs to perform multiple iterations of CSI-RS and PMI reporting between SRS transmissions such as illustrated in FIG. 13.

FIG. 13 illustrates an example 1300 of SRS periodicity. The example SRS periodicity of FIG. 13 is for illustration only. Different embodiments of SRS periodicity could be used without departing from the scope of this disclosure.

In the example of FIG. 13, UE 810, TRP 1, and TRP 2 are configured such that each SRS transmission from UE 810 is followed by multiple beamformed CSI-RS transmissions from TRP 1 and TRP 2. In the example of FIG. 12, there will be N number of CSI-RS transmissions to cover N iterations (corresponding to N PMI reports), and a fraction of N SRS transmissions.

Although FIG. 13 illustrates an example 1300 of SRS periodicity, various changes may be made to FIG. 13. For example, various changes to the number of iterations, the number of TRPs, etc. could be made according to particular needs.

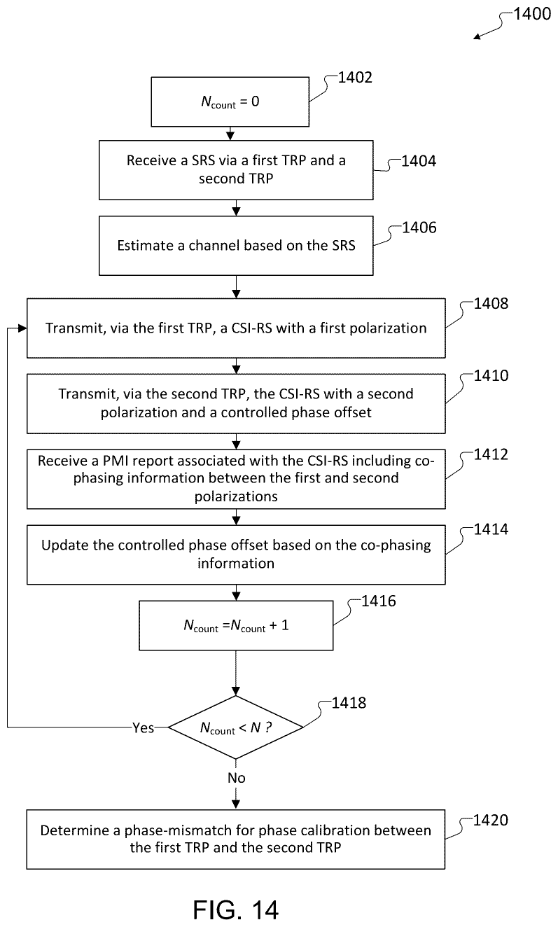

FIG. 14 illustrates a method 1400 for PMI feedback-based calibration in distributed MIMO performed by a network entity according to embodiments of the present disclosure. An embodiment of the method illustrated in FIG. 14 is for illustration only. One or more of the components illustrated in FIG. 14 may be implemented in specialized circuitry configured to perform the noted functions or one or more of the components may be implemented by one or more processors executing instructions to perform the noted functions. Other embodiments of PMI feedback-based calibration in distributed MIMO could be used without departing from the scope of this disclosure.

As illustrated in FIG. 14, the method 1400 begins at step 1402. At step 1404, a network entity such as gNB 102 or NE 104 of FIG. 1, receives, from a UE, via a first TRP and a second TRP, a SRS. At step 1406, the network entity estimates a channel based on the received SRS. At step 1408, the network entity begins to iterate the series of steps 1408-1414 for a number of iterations N. The number of iterations N is related to a number of CSI reports including co-phasing information used to determine a phase mis-match for phase calibration between the first TRP and the second TRP. In the example of FIG. 14, the current iteration of Nis represented by a counter N_{count}. At step 1408, the network entity transmits, via the first TRP, a CSI-RS with a first polarization. At step 1410, the network entity transmits, via the second TRP, the CSI-RS with a second polarization and a controlled phase offset. At step 1412, the network entity receives, from the UE, a PMI report associated with the CSI-RS. The PMI report includes co-phasing information between the first polarization and the second polarization. At step 1414 the network entity updates the controlled phase offset, based on the co-phasing information. The current iteration of N is completed at step 1416. At step 1418, if additional CSI reports are needed, the process proceeds back to step 1408 to begin another iteration. If the number of CSI reports are sufficient, the process proceeds to step 1420. At step 1420, based on the controlled phase offset and the co-phasing information, the network entity determines a phase mis-match for phase calibration between the first TRP and the second TRP.

Although FIG. 14 illustrates one example of a method 1400 for PMI feedback-based calibration in distributed MIMO, various changes may be made to FIG. 14. For example, while shown as a series of steps, various steps in FIG. 14 could overlap, occur in parallel, occur in a different order, or occur any number of times.

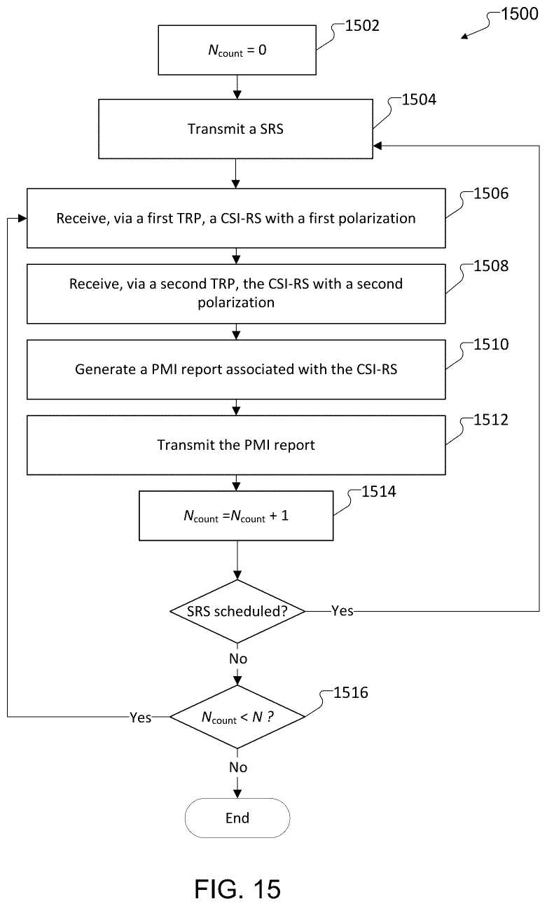

FIG. 15 illustrates a method 1500 for PMI feedback-based calibration in distributed MIMO performed by a UE according to embodiments of the present disclosure. An embodiment of the method illustrated in FIG. 15 is for illustration only. One or more of the components illustrated in FIG. 15 may be implemented in specialized circuitry configured to perform the noted functions or one or more of the components may be implemented by one or more processors executing instructions to perform the noted functions. Other embodiments of PMI feedback-based calibration in distributed MIMO could be used without departing from the scope of this disclosure.

As illustrated in FIG. 15, the method 1500 begins at step 1502. At step 1504, a UE such as UE 810 of FIG. 8, transmits a SRS. At step 1506, the UE begins to iterate the series of steps 1506-1512 for a number of iterations N. The number of iterations Nis related to a number of CSI reports including co-phasing information used to determine a phase mis-match for phase calibration between the first TRP and the second TRP. In the example of FIG. 15, the current iteration of N is represented by a counter N_{count}. At step 1506, the UE, receives, via a first TRP, a CSI-RS with a first polarization. At step 1508, the network entity receives, via a second TRP, the CSI-RS with a second polarization and a controlled phase offset. At step 1510, the UE, a generates a PMI report associated with the CSI-RS. The PMI report includes co-phasing information between the first polarization and the second polarization. At step 1512 the UE transmits the PMI report. The current iteration of Nis completed at step 1514. At step 1516, if additional CSI reports are needed, the process proceeds back to step 1506 to begin another iteration. Otherwise, If the number of CSI reports is sufficient, the process ends.

Although FIG. 15 illustrates one example of a method 1500 for PMI feedback-based calibration in distributed MIMO, various changes may be made to FIG. 15. For example, while shown as a series of steps, various steps in FIG. 15 could overlap, occur in parallel, occur in a different order, or occur any number of times.

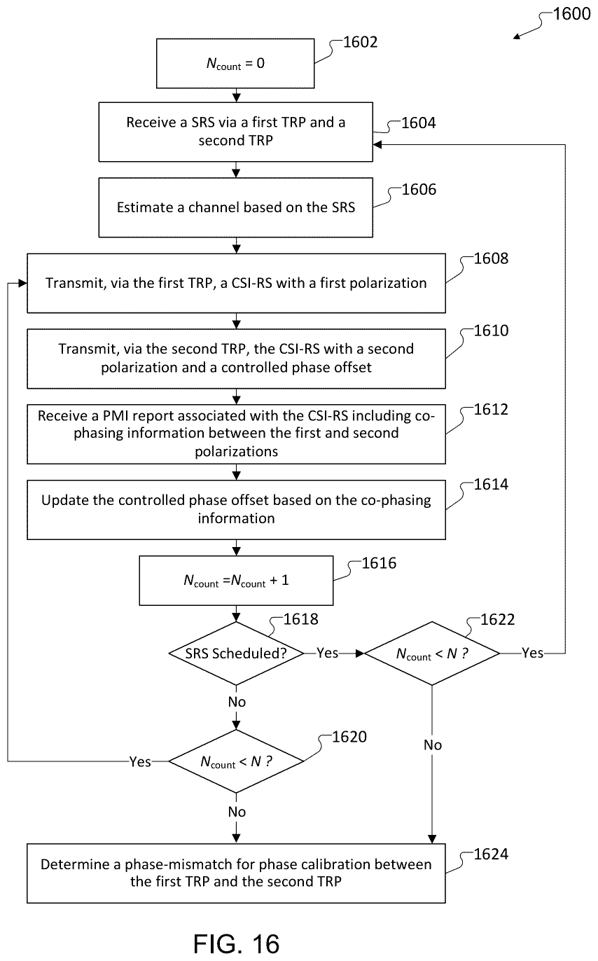

FIG. 16 illustrates a method 1600 for PMI feedback-based calibration in distributed MIMO performed by a network entity according to embodiments of the present disclosure. An embodiment of the method illustrated in FIG. 16 is for illustration only. One or more of the components illustrated in FIG. 16 may be implemented in specialized circuitry configured to perform the noted functions or one or more of the components may be implemented by one or more processors executing instructions to perform the noted functions. Other embodiments of PMI feedback-based calibration in distributed MIMO could be used without departing from the scope of this disclosure.

As illustrated in FIG. 16, the method 1600 begins at step 1602. At step 1604, a network entity such as gNB 102 or NE 104 of FIG. 1, receives, from a UE, via a first TRP and a second TRP, a SRS. At step 1606, the network entity estimates a channel based on the received SRS. At step 1608, the network entity begins to iterate the series of steps 1408-1414 for a number of iterations N. The number of iterations N is related to a number of CSI reports including co-phasing information used to determine a phase mis-match for phase calibration between the first TRP and the second TRP. In the example of FIG. 16, the current iteration of N is represented by a counter N_{count}. At step 1608, the network entity transmits, via the first TRP, a CSI-RS with a first polarization. At step 1610, the network entity transmits, via the second TRP, the CSI-RS with a second polarization and a controlled phase offset. At step 1612, the network entity receives, from the UE, a PMI report associated with the CSI-RS. The PMI report includes co-phasing information between the first polarization and the second polarization. At step 1414 the network entity updates the controlled phase offset, based on the co-phasing information. The current iteration of Nis completed at step 1416. At step 1418, if an SRS is scheduled, the process proceeds to step 1622. Otherwise, if no SRS is scheduled, the process proceeds to step 1620. At step 1620, if additional CSI reports are needed, the process proceeds back to step 1608 to begin another iteration. If the number of CSI reports are sufficient, the process proceeds to step 1624. At step 1622, if additional CSI reports are needed, the process proceeds back to step 1602 to begin another iteration. Otherwise, the process proceeds to step 1624. At step 1624, based on the controlled phase offset and the co-phasing information, the network entity determines a phase mis-match for phase calibration between the first TRP and the second TRP.

Although FIG. 16 illustrates one example of a method 1600 for PMI feedback-based calibration in distributed MIMO, various changes may be made to FIG. 16. For example, while shown as a series of steps, various steps in FIG. 16 could overlap, occur in parallel, occur in a different order, or occur any number of times.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A network entity comprising:
a memory; and
a processor operably coupled to the memory, the processor configured to:
receive, from a user equipment (UE), via a first transmit-receive point (TRP) and a second TRP, a sounding reference signal (SRS);
estimate a channel based on the received SRS; and
for N iterations:
transmit, via the first TRP, a channel state information reference signal (CSI-RS) with a first polarization;
transmit, via the second TRP, the CSI-RS with a second polarization and a controlled phase offset;
receive, from the UE, a precoding matrix indicator (PMI) report associated with the CSI-RS including co-phasing information between the first polarization and the second polarization; and
update the controlled phase offset, based on the co-phasing information; and
after the N iterations, based on the controlled phase offset and the co-phasing information, determine a phase mis-match for phase calibration between the first TRP and the second TRP.

2. The network entity of claim 1, wherein the processor is further configured to:
assign a first set of CSI-RS ports from a CSI-RS resource to the first TRP;
assign a second set of CSI-RS ports from the CSI-RS resource to the second TRP;
apply a first set of virtualization weights to the first set of CSI-RS ports; and
apply a second set of virtualization weights to the second set of CSI-RS ports,
wherein the CSI-RS is transmitted with the first polarization based on the first set of virtualization weights, and
wherein the CSI-RS is transmitted with the second polarization based on the second set of virtualization weights.

3. The network entity of claim 2, wherein at least one of:
a plurality of TXRUs comprised by the first TRP are virtualized to a single CSI-RS port from the first set of CSI-RS ports; and
a plurality of TXRUs comprised by the second TRP are virtualized to a single CSI-RS port from the second set of CSI-RS ports.

4. The network entity of claim 1, wherein the processor is further configured to:
for each of the N iterations:
determine, based on the estimated channel, a precoder for each of a plurality of TXRUs comprised by the first TRP; and
determine, based on the estimated channel, a precoder and a controlled phase offset for each of a plurality of TXRUs comprised by the second TRP,
wherein the CSI-RS is transmitted by the first TRP based on the determined precoder for each of the plurality of TXRUs comprised by the first TRP, and
wherein the CSI-RS is transmitted by the second TRP based on the determined precoder and the controlled phase offset for each of the plurality of TXRUs comprised by the second TRP.

5. The network entity of claim 1, wherein:
the UE is configured to report only rank=1 PMI, and
the PMI report received from the UE is generated by the UE based on the configuration to report only rank=1 PMI.

6. The network entity of claim 1, wherein the processor is further configured to receive an SRS from the UE, via the first TRP and the second TRP, and estimate the channel based on the received SRS for each iteration.

7. The network entity of claim 1, wherein the processor is further configured to, during an iteration, based on an SRS periodicity:
receive an additional SRS from the UE via the first TRP and the second TRP; and estimate the channel based on the received additional SRS,
wherein the SRS periodicity is less than N.

8. The network entity of claim 1, wherein the processor is further configured to, for at least one of the iterations:
transmit, via the first TRP, at least one additional channel state information reference signal (CSI-RS) with the first polarization;
transmit, via the second TRP, the at least one additional CSI-RS with the second polarization and a controlled phase offset; and
receive, from the UE, at least one additional precoding matrix indicator (PMI) report associated with the at least one additional CSI-RS including additional co-phasing information between the first polarization and the second polarization,
wherein the controlled phase offset is updated based on the additional co-phasing information.

9. A user equipment (UE) comprising:
a processor configured to generate precoding matrix indicator (PMI) reports; and
a transceiver operably coupled to the processor, the transceiver configured to:
transmit a sounding reference signal (SRS); and
for N iterations:
receive, via a first transmit-receive point (TRP), a channel state information reference signal (CSI-RS) with a first polarization;
receive, via a second TRP, the CSI-RS with a second polarization and a controlled phase offset; and
transmit a PMI report associated with the CSI-RS, generated by the processor, including co-phasing information between the first polarization and the second polarization.

10. The UE of claim 9,
wherein the CSI-RS is transmitted with the first polarization based on a first set of virtualization weights, and
wherein the CSI-RS is transmitted with the second polarization based on a second set of virtualization weights.

11. The UE of claim 9,
wherein the CSI-RS is transmitted by a first TRP based on a determined precoder for each of a plurality of TXRUs comprised by the first TRP, and
wherein the CSI-RS is transmitted by a second TRP based on a determined precoder and a controlled phase offset for each of a plurality of TXRUs comprised by the second TRP.

12. The UE of claim 11, wherein at least one of:
a plurality of TXRUs comprised by the first TRP are virtualized to a single CSI-RS port from a first set of CSI-RS ports; and
a plurality of TXRUs comprised by the second TRP are virtualized to a single CSI-RS port from a second set of CSI-RS ports.

13. The UE of claim 9, wherein:
the processor is further configured to generate PMI reports that report only on rank=1 PMI; and
the transmitted PMI report associated with the CSI-RS is generated by the processor based on the configuration to report only rank=1 PMI.

14. The UE of claim 9, wherein transceiver is further configured to transmit an SRS for each iteration.

15. The UE of claim 9, wherein the transceiver is further configured to, during an iteration, based on an SRS periodicity:
transmit an additional SRS,
wherein the SRS periodicity is less than N.

16. A method of operating a network entity comprising:
receiving, from a user equipment (UE), via a first transmit-receive point (TRP) and a second TRP, a sounding reference signal (SRS);
estimating a channel based on the received SRS; and
for N iterations:
determining, based on the estimated channel, a precoder for each of a plurality of TXRUs comprised by the first TRP; and
determining, based on the estimated channel, a precoder and a controlled phase offset for each of a plurality of TXRUs comprised by the second TRP,
transmitting, via the first TRP, based on the determined precoder for each of the plurality of TXRUs comprised by the first TRP, a channel state information reference signal (CSI-RS) with a first polarization;
transmitting, via the second TRP, based on the determined precoder and the controlled phase offset for each of the plurality of TXRUs comprised by the second TRP, the CSI-RS with a second polarization and a controlled phase offset;
receiving, from the UE, a precoding matrix indicator (PMI) report associated with the CSI-RS including co-phasing information between the first polarization and the second polarization; and
updating the controlled phase offset, based on the co-phasing information; and
after the N iterations, based on the controlled phase offset and the co-phasing information, determining a phase mis-match for phase calibration between the first TRP and the second TRP.

17. The method of claim 16, further comprising:
assigning a first set of CSI-RS ports from a CSI-RS resource to the first TRP;
assigning a second set of CSI-RS ports from the CSI-RS resource to the second TRP;
applying a first set of virtualization weights to the first set of CSI-RS ports; and
applying a second set of virtualization weights to the second set of CSI-RS ports,
wherein the CSI-RS is transmitted with the first polarization based on the first set of virtualization weights,
wherein the CSI-RS is transmitted with the second polarization based on the second set of virtualization weights, and
wherein at least one of:
a plurality of TXRUs comprised by the first TRP are virtualized to a single CSI-RS port from the first set of CSI-RS ports; and
a plurality of TXRUs comprised by the second TRP are virtualized to a single CSI-RS port from the second set of CSI-RS ports.

18. The method of claim 16, wherein:
the UE is configured to report only rank=1 PMI, and
the PMI report received from the UE is generated by the UE based on the configuration to report only rank=1 PMI.

19. The method of claim 16, wherein the method comprises receiving an SRS from the UE, via the first TRP and the second TRP, and estimating the channel based on the received SRS for each iteration.

20. The method of claim 16, further comprising:
during an iteration, based on an SRS periodicity:
receiving an additional SRS from the UE via the first TRP and the second TRP; and
estimating the channel based on the received additional SRS,
wherein the SRS periodicity is less than N.
